(19) United States
(12) Patent Application Publication
(10) Pub. No.: US 2012/0061535 A1
(43) Pub. Date: Mar. 15, 2012

(54) METHOD FOR MANUFACTURING A CORNER FIXING BRACKET AND A CORNER FIXING BRACKET

(76) Inventor: Kaoru Taneichi, Atsugi-shi (JP)

(21) Appl. No.: 12/882,672

(22) Filed: Sep. 15, 2010

(51) Int. Cl. F16M 13/02; B23P 17/00

(52) U.S. Cl. 248/220.1; 29/592

(57) ABSTRACT

A method for manufacturing a corner fixing bracket has: a formation process of a tabular fixing bracket body which bends a generally central part to a predetermined angle; a formation process of plural pin-shaped nails which form plural pin-shaped nails by punching, in both ends parts except a central part of a fixing bracket body formed by said formation process of a fixing bracket body; and a bending process which bends a generally central part at 45 degrees or 90 degrees, after said formation process of plural pin-shaped nails.

### BACKGROUND OF THE INVENTION

The present invention relates to a method for manufacturing a corner fixing bracket and a corner fixing bracket for a timber material which fixes the connecting part of a beam and a beam, the connecting part of a beam and a crossbeam, the connecting part of a rafter and a beam, and so on.

Conventionally, the inventor discloses and sells a corner fixing bracket of a timber material comprising: a fixing bracket of one side having;

a L character-like fixing bracket body, plural pin-shaped nails formed by punching in a plate of a long side of a fixing bracket body, and plural pin-shaped nails insert holes which are formed in a plate of a shorter side of a fixing bracket body, and a fixing bracket of another side having; a crank type fixing bracket body formed via a bent part so that it might overlap with a plate of a shorter side of the fixing bracket of one side, plural pin-shaped nails formed by punching in a base part of a fixing bracket body, and an insertion hole of the nail formed in a part of a fixing bracket body which overlaps with the fixing bracket of one side and in the part corresponding to the pin-shaped nail insert hole of a plate of a shorter side of the fixing bracket of one side.

And a corner fixing bracket prevents gap of a connecting part, and is attached easily, and is connected by sufficient strength.

However, the cost becomes high because it becomes two parts.
Reference document: JP, 3927931, B

### SUMMARY OF THE INVENTION

An object of the present invention is to supply a method for manufacturing a corner fixing bracket and a corner fixing bracket which are no gap and will attach the connecting part of a beam and a beam, the connecting part of a beam and a crossbeam, the connecting part of a rafter and a beam, and so on, easily by sufficient strength and which will be formed with one parts and will be cheaply manufactured.

The present invention is understood to encompass embodiments which include all or only a portion of the above objects, features and advantages which, unless recited in claims defining the invention, are understood not to limit interpretation of such claims. The above, and other objects, features and advantages of the present invention will become apparent from the following description read in conjunction with the accompanying drawings, in which like reference numerals designate the same elements. It is to be expressly understood, however, that the drawings are for the purpose of illustration and description only, and are not intended as a definition of the limits of the invention.

In order to achieve the above mentioned purpose, the present invention, in a first aspect thereof, comprises: a formation process of a tabular fixing bracket body which bends a generally central part to a predetermined angle; a formation process of plural pin-shaped nails which form plural pin-shaped nails by punching, in both ends parts except a central part of a fixing bracket body formed by said formation process of a fixing bracket body; and a bending process which bends a generally central part at 45 degrees or 90 degrees, after said formation process of plural pin-shaped nails.

According to another aspect of the invention, the present invention comprises: a tabular fixing bracket body which bent to a predetermined angle at a generally central part; and plural pin-shaped nails which is formed by punching, in both ends parts except a generally central part of said fixing bracket body.

As is clear from the above-mentioned explanations, the present invention as hereinabove defined provides the effects enumerated below.

(1) The present invention comprises: a formation process of a tabular fixing bracket body which bends a generally central part to a predetermined angle; a formation process of plural pin-shaped nails which form plural pin-shaped nails by punching, in both ends parts except a central part of a fixing bracket body formed by said formation process of a fixing bracket body; and a bending process which bends a generally central part at 45 degrees or 90 degrees, after said formation process of plural pin-shaped nails. Therefore, the present invention will be formed with one parts and will be manufactured cheaply.

(2) As described in the above (1), the process is the following.

A tabular fixing bracket body is formed so that a generally central part may bend to a predetermined angle, plural pin-shaped nails are formed by punching in the both ends parts, and a central part is bent so that it may twist at 45 degrees or 90 degrees. Therefore, the manufacture is easy, since a special device for processing is not used but the common device for processing is used.

(3) Claim 2 provides the same effects as those described in the above (1) to (2).

### BRIEF DESCRIPTION OF THE DRAWINGS

FIG. 1 is a process diagram to practice a first preferred embodiment of the present invention.

FIG. 2 is a front view of a fixing bracket body of a first preferred embodiment to practice the present invention.

FIG. 3 is an illustration of a formation process of plural pin-shaped nails of the first preferred embodiment to practice the present invention.

FIG. 4 is an illustration of a bending process of the first preferred embodiment to practice the present invention.

FIG. 5 is a front view of a corner fixing bracket of a first preferred embodiment to practice the present invention.

FIG. 6 is a side view of a corner fixing bracket of a first preferred embodiment to practice the present invention.

FIG. 7 is a plan view of a corner fixing bracket of a first preferred embodiment to practice the present invention.

FIG. 8 is an illustration of usage state of the first preferred embodiment to practice the present invention.

FIG. 9 is a process diagram to practice a second embodiment of the present invention.

FIG. 10 is a process diagram of a bending process to practice a second embodiment of the present invention.

FIG. 11 is a front view of a corner fixing bracket of a second preferred embodiment to practice the present invention.

FIG. 12 is a plan view of a corner fixing bracket of a second preferred embodiment to practice the present invention.

FIG. 13 is a process diagram to practice a third embodiment of the present invention.

FIG. 14 is a front view of a fixing bracket body of a third preferred embodiment to practice the present invention.

FIG. 15 is a process diagram of a bending process to practice a third embodiment of the present invention.

FIG. 16 is a front view of a corner fixing bracket of a third preferred embodiment to practice the present invention.

FIG. 17 is a plan view of a corner fixing bracket of a third preferred embodiment to practice the present invention.

FIG. 18 is an illustration of usage state of the third preferred embodiment to practice the present invention.

FIG. 19 is a process diagram to practice a fourth embodiment of the present invention.

FIG. 20 is a process diagram of a bending process to practice a fourth embodiment of the present invention.

FIG. 21 is a front view of a corner fixing bracket of a fourth preferred embodiment to practice the present invention.

FIG. 22 is a side view of a corner fixing bracket of a fourth preferred embodiment to practice the present invention.

FIG. 23 is a plan view of a corner fixing bracket of a fourth preferred embodiment to practice the present invention.

FIG. 24 is a process diagram to practice a fifth embodiment of the present invention.

FIG. 25 is a process diagram of a formation process of plural pin-shaped nails to practice a fifth embodiment of the present invention.

FIG. 26 is a front view of a corner fixing bracket of a fifth preferred embodiment to practice the present invention.

FIG. 27 is a side view of a corner fixing bracket of a fifth preferred embodiment to practice the present invention.

FIG. 28 is a plan view of a corner fixing bracket of a fifth preferred embodiment to practice the present invention.

FIG. 29 is a process diagram to practice a sixth embodiment of the present invention.

FIG. 30 is a process diagram of a formation process of plural pin-shaped nails to practice a sixth embodiment of the present invention.

FIG. 31 is a front view of a corner fixing bracket of a sixth preferred embodiment to practice the present invention.

FIG. 32 is a side view of a corner fixing bracket of a sixth preferred embodiment to practice the present invention.

FIG. 33 is a front view of a corner fixing bracket of a seventh preferred embodiment to practice the present invention.

FIG. 34 is a side view of a corner fixing bracket of a seventh preferred embodiment to practice the present invention.

FIG. 35 is a plan view of a corner fixing bracket of a seventh preferred embodiment to practice the present invention.

FIG. 36 is a process diagram to practice a seventh embodiment of the present invention.

FIG. 37 is a front view of a corner fixing bracket of a eighth preferred embodiment to practice the present invention.

FIG. 38 is a side view of a corner fixing bracket of a eighth preferred embodiment to practice the present invention.

FIG. 39 is a plan view of a corner fixing bracket of a eighth preferred embodiment to practice the present invention.

### DETAILS DESCRIPTION OF THE INVENTION

Preferred embodiments to practice the present invention will now be described in detail below referring to the accompanying drawings.

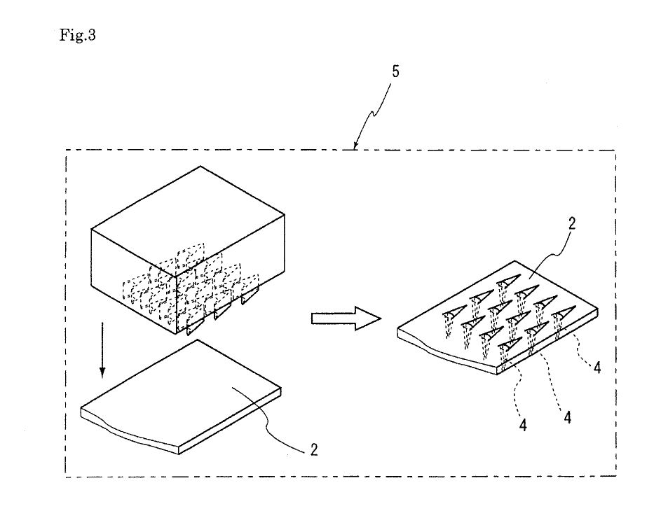

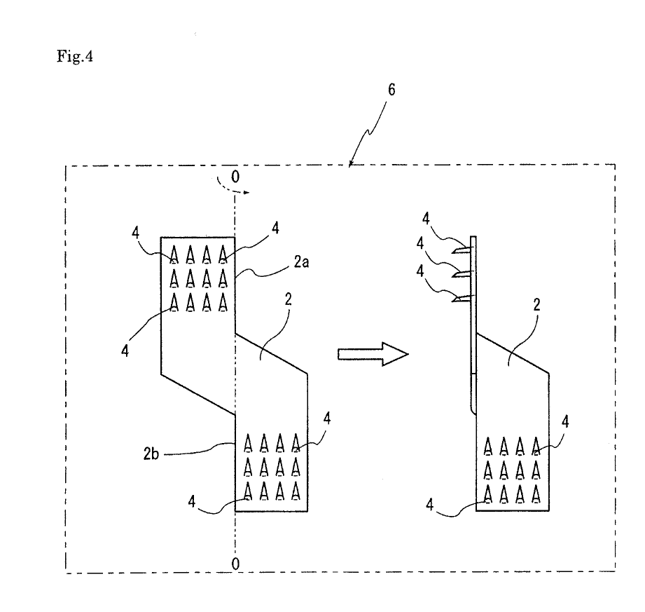

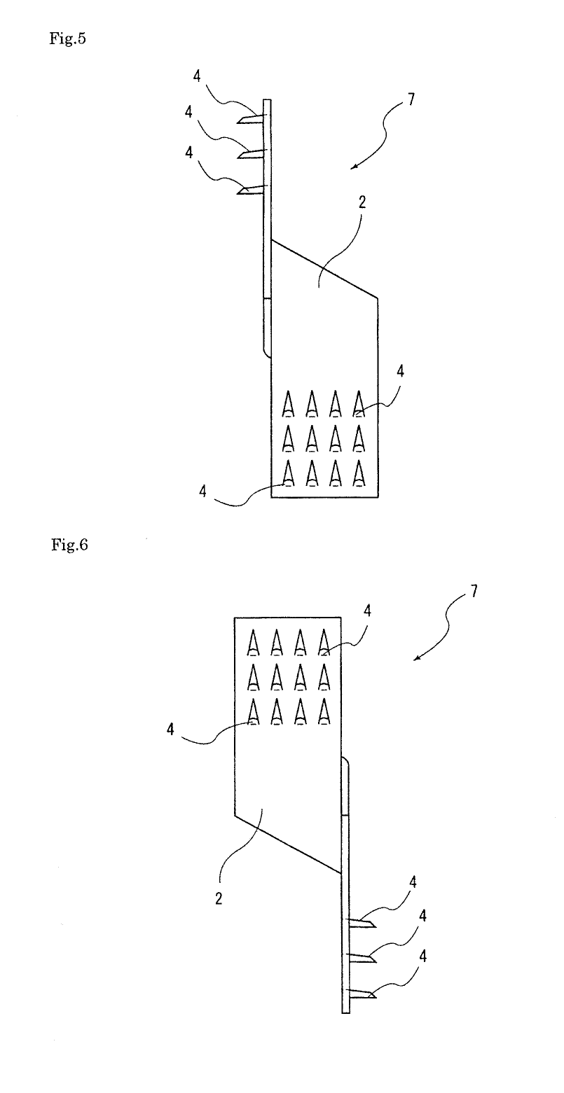

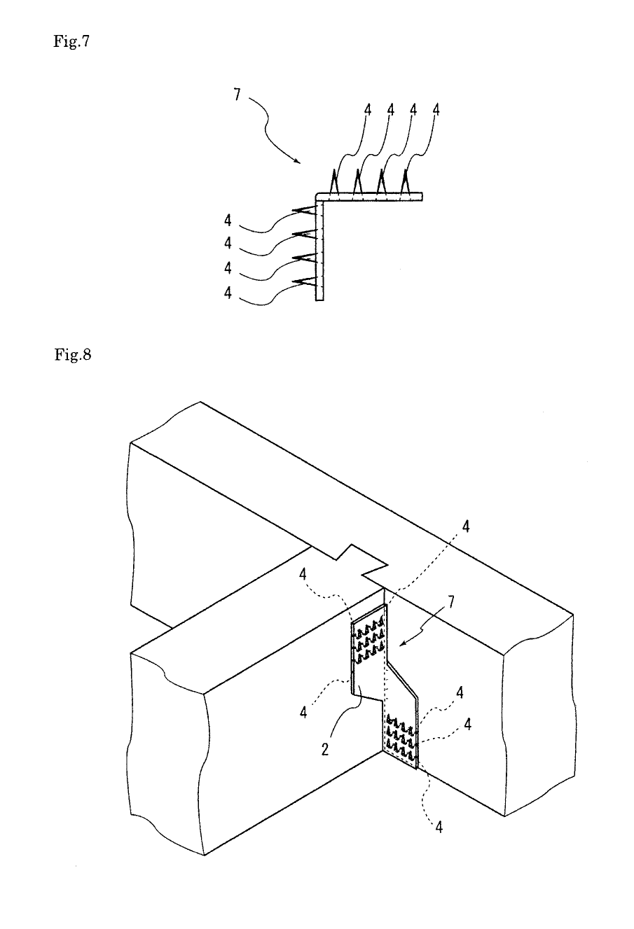

FIG. 1 to FIG. 8 illustrate a first embodiment to practice the present invention wherein 1 is a method for manufacturing a corner fixing bracket. A method for manufacturing a corner fixing bracket 1 processes a corner fixing bracket body so that generally central part may bend to a predetermined angle.

In an embodiment of the present invention, a method for manufacturing a corner fixing bracket 1 bends and processes a central part into 90 degrees. For example, the method for manufacturing a corner fixing bracket 1 comprises: a formation process of a fixing bracket body 3 which formed a tabular fixing bracket body 2 by a press-punching so that both side part may be located on the same line; a formation process of plural pin-shaped nails 5 which form plural pin-shaped nails 4 by punching, in both ends parts except a central part of fixing bracket body 2, after the formation process of fixing bracket body 3 or at the same time; a bending process 6 which bends a generally central part 90 degrees so that plural pin-shaped nails may be located in outside, after a formation process of plural pin-shaped nails 5, that is, both a right side 2a and a left side 2b of the fixing bracket body 2 connect at the same line.

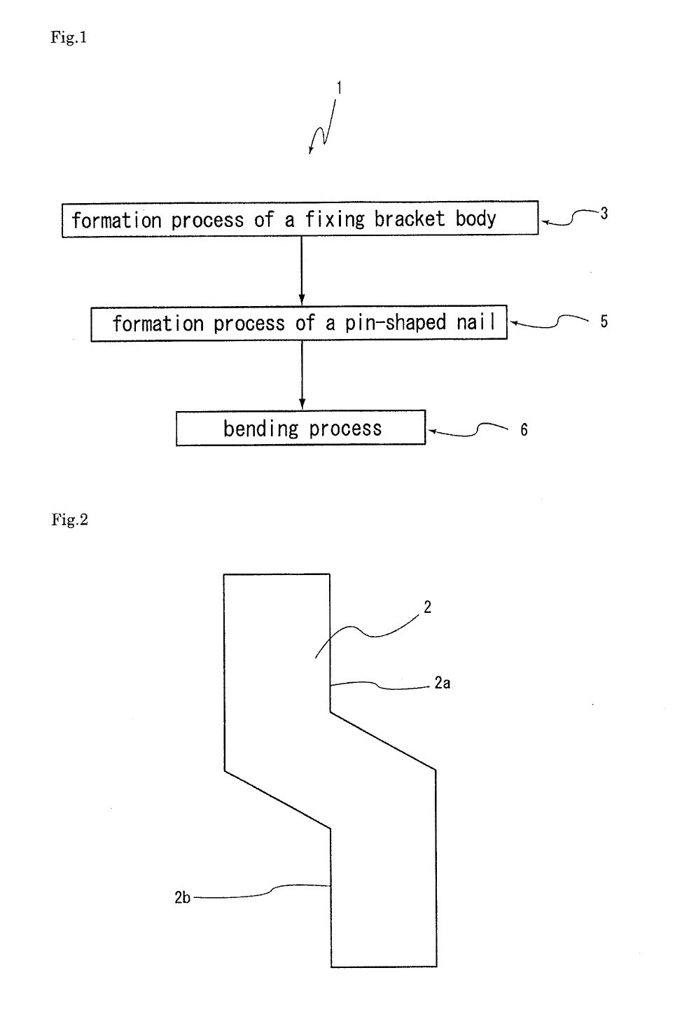

If it adds, in FIG. 2, the central part of a fixing bracket body 2 does not have a bend line, and is flat. If a fixing bracket body 2 is bent by a bending process 6, a bend line appears in the bent part between a right side 2a of a upper plate and a left side 2b of a lower plate. Then, a right side 2a of a upper plate is connected with the same line as a left side 2b of lower plate via a bend line of a central part. Further, plural pin-shaped nails 4 are used as a nail. And if it is processing in punching, the shape is free.

A corner fixing bracket manufactured in this way is bent 90 degrees in the central part, and plural pin-shaped nails are formed in the flat part of both ends parts. Therefore, the corner fixing bracket 7 will be used when it fixes the connecting part of a position as shown in FIG. 8, which differs in a position 90 degrees, such as beams or a beam and a crossbeam.

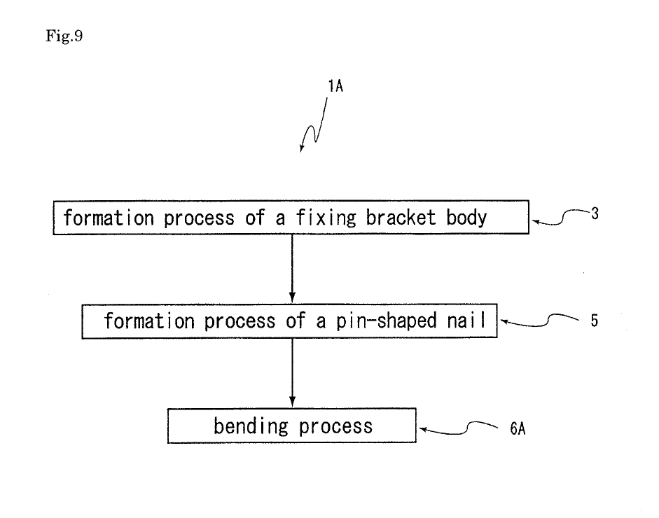

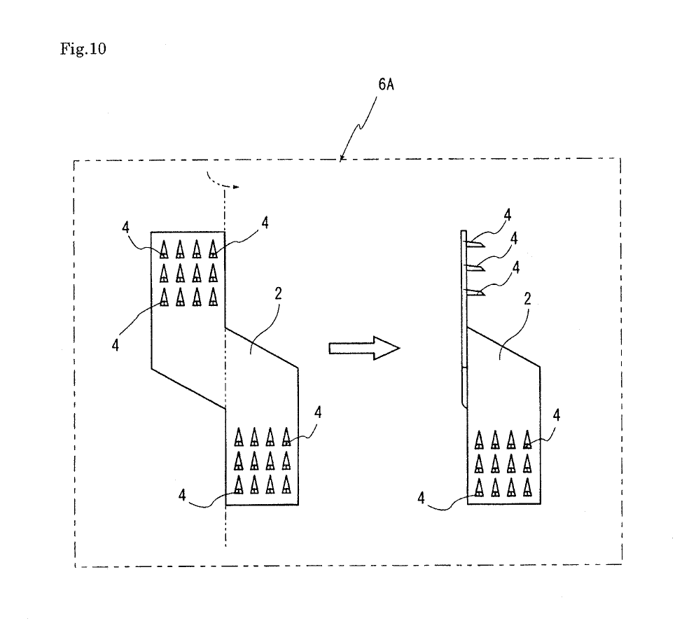

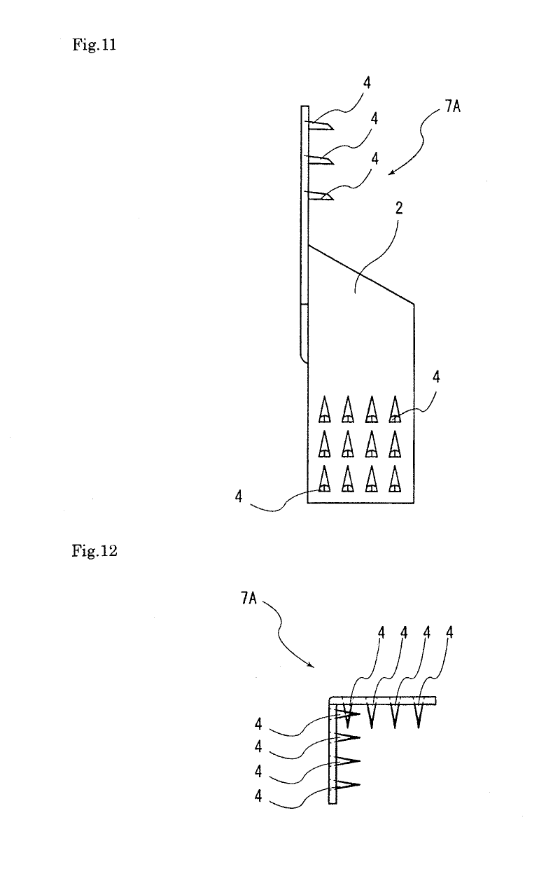

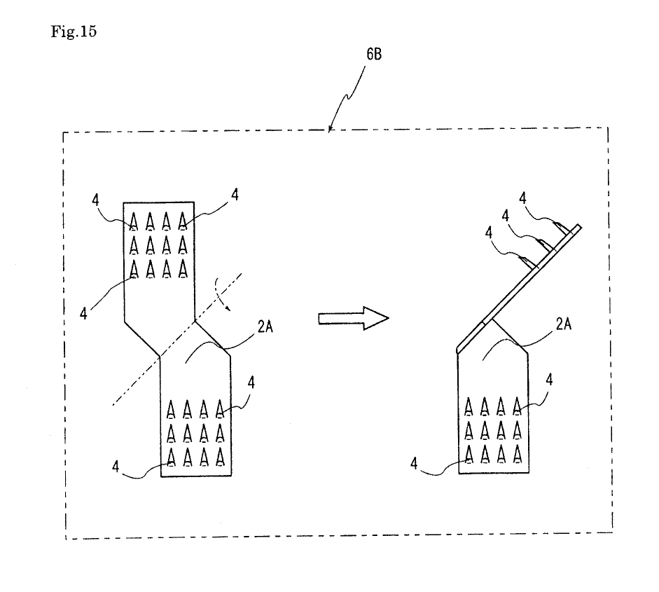

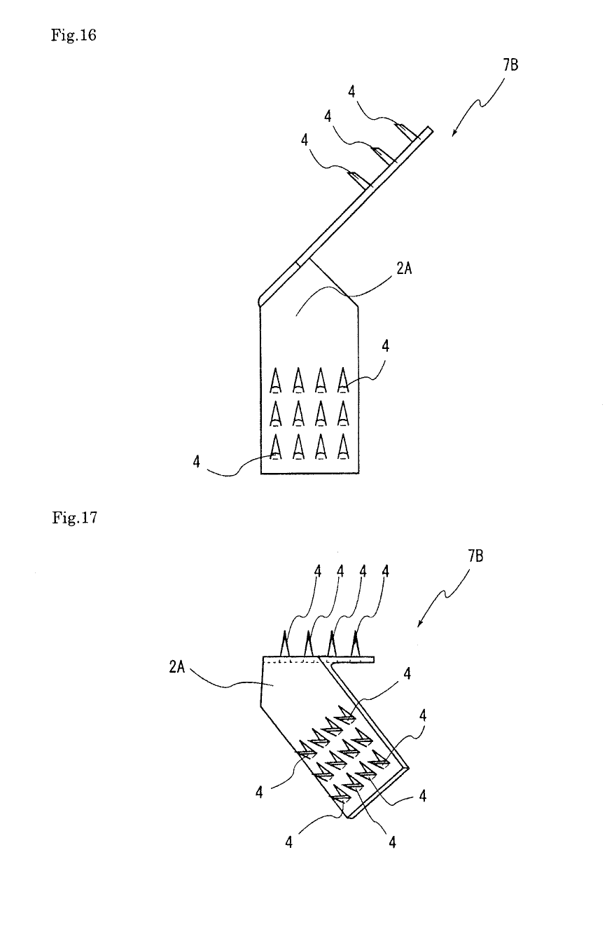

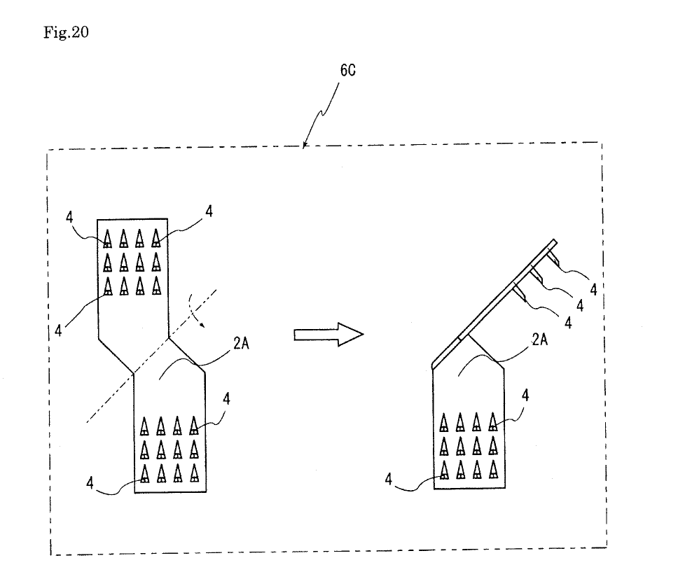

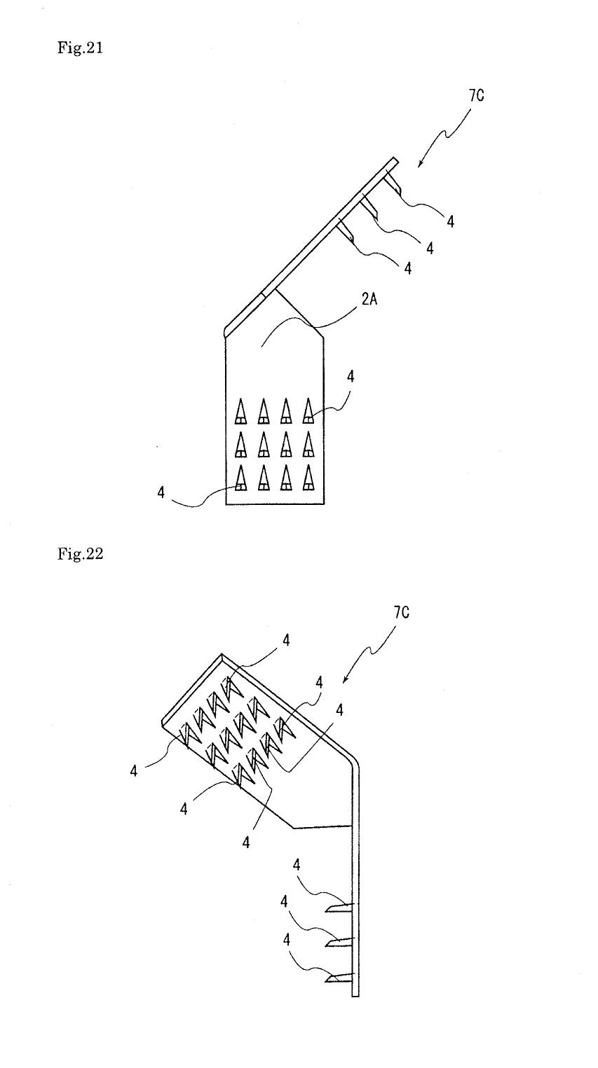

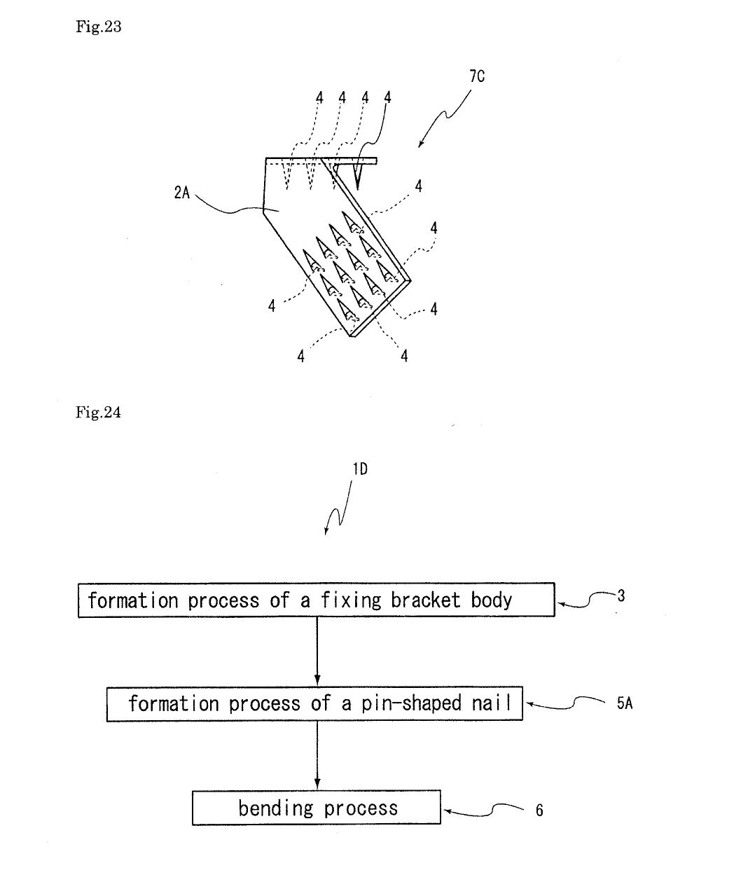

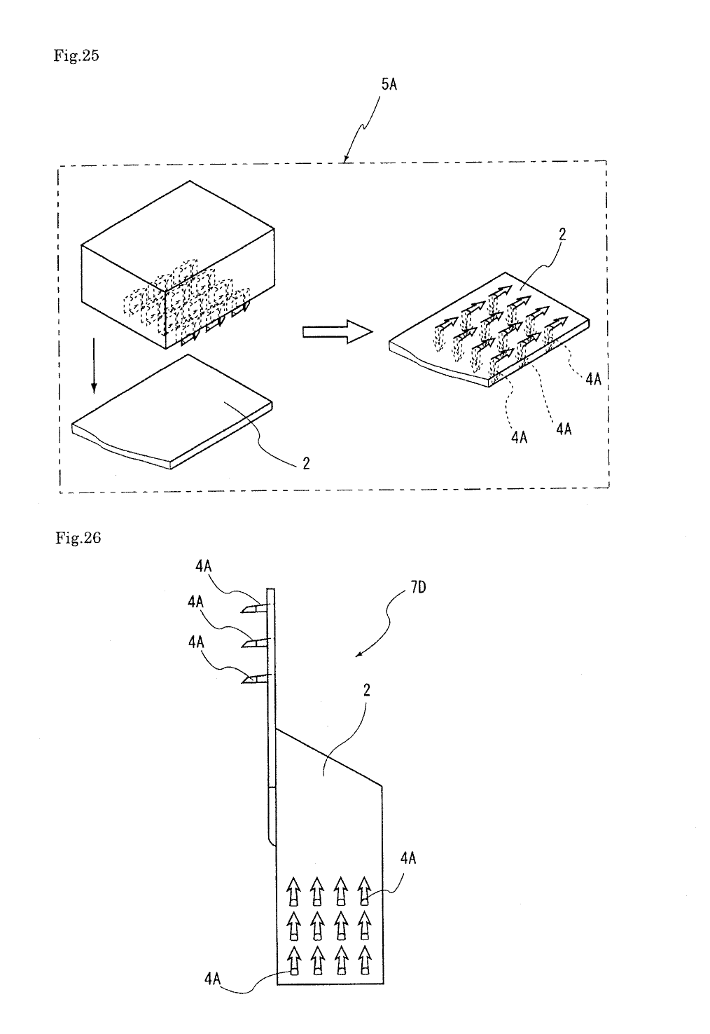

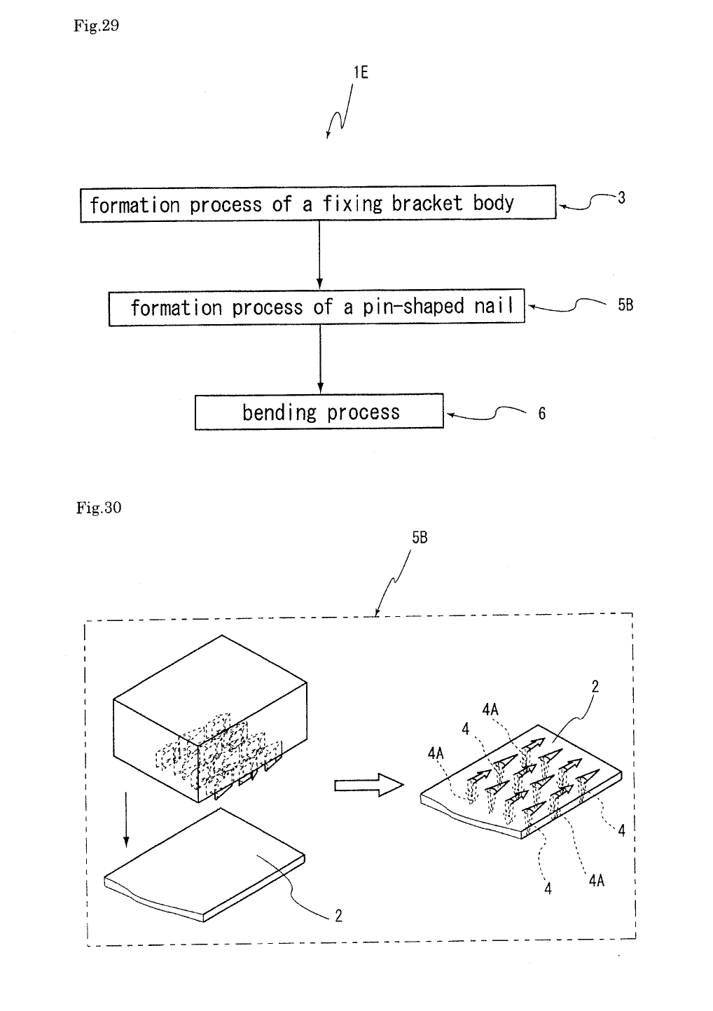

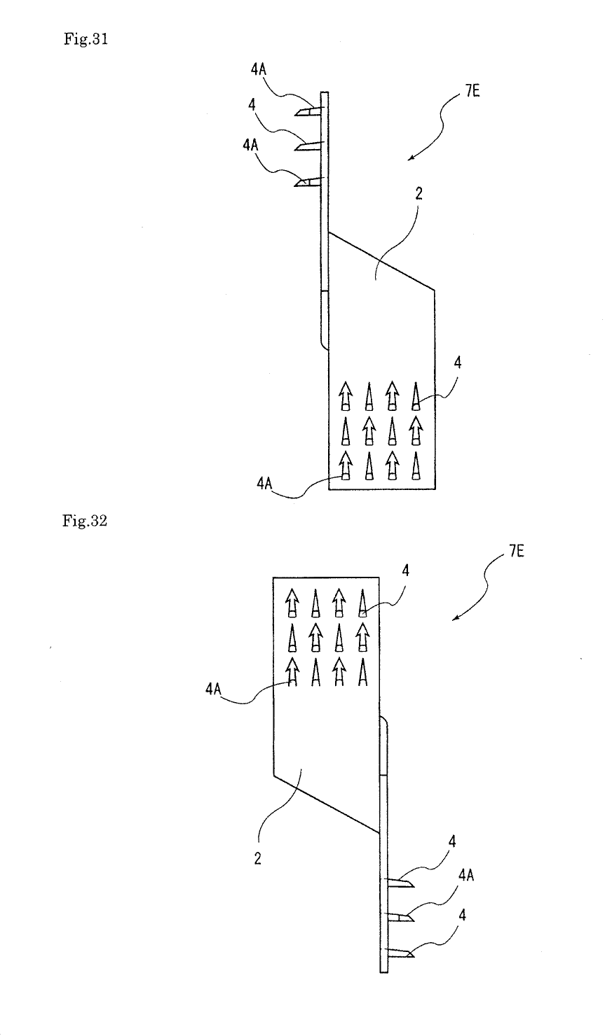

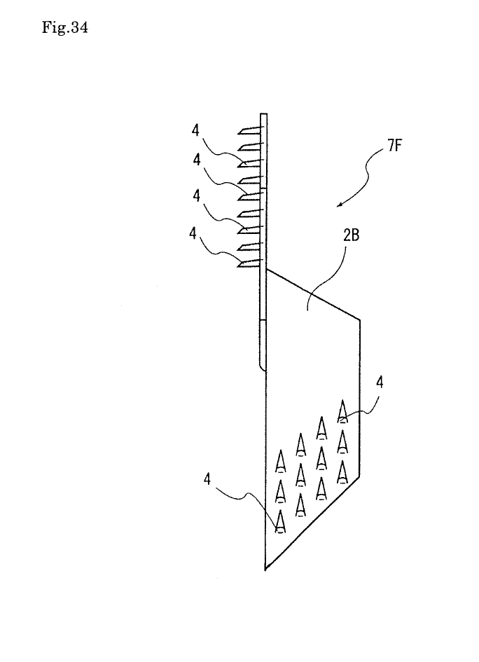

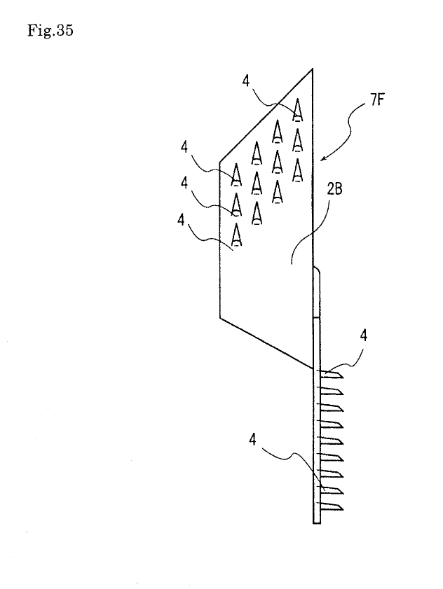

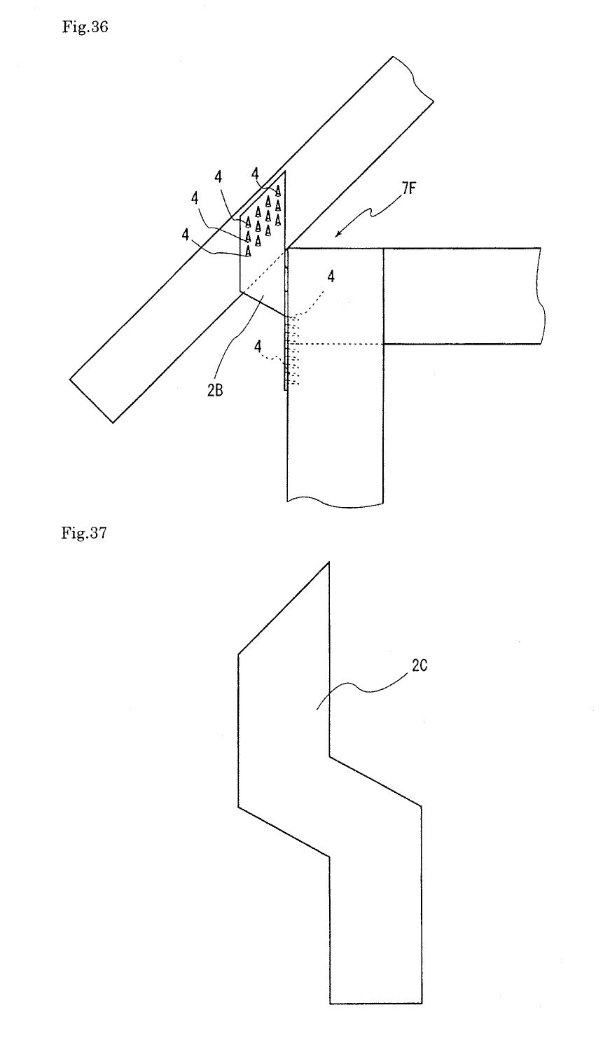

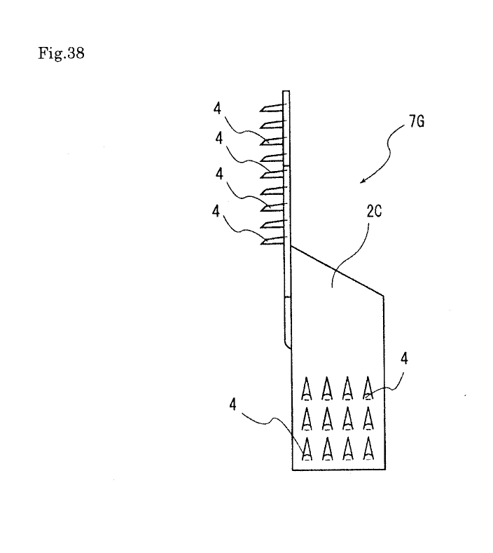

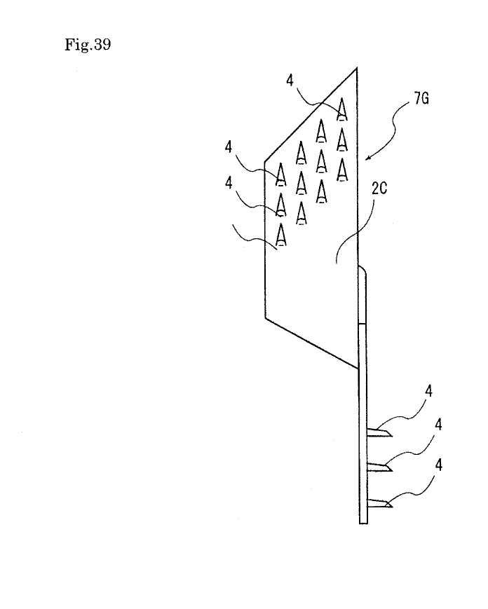

Explained next are other embodiments to practice the present invention as illustrated in FIG. 9 to FIG. 39. In explaining these other embodiments to practice the present invention, the same component parts as those in the first preferred embodiment to practice the present invention, are given the same numerals in order to avoid the overlapping explanations.

A second embodiment to practice the present invention is shown in FIGS. 9 to 12. It is distinguished from the first preferred embodiment that: a corner fixing bracket 7A is manufactured by performing a bending process 6A so that plural pin-shaped nails 4 may be located inside. Therefore, a corner fixing bracket 7A manufactured by a method for manufacturing a corner fixing bracket 1A as described above will have similar action effects to that according to the first preferred embodiment to practice the present invention.

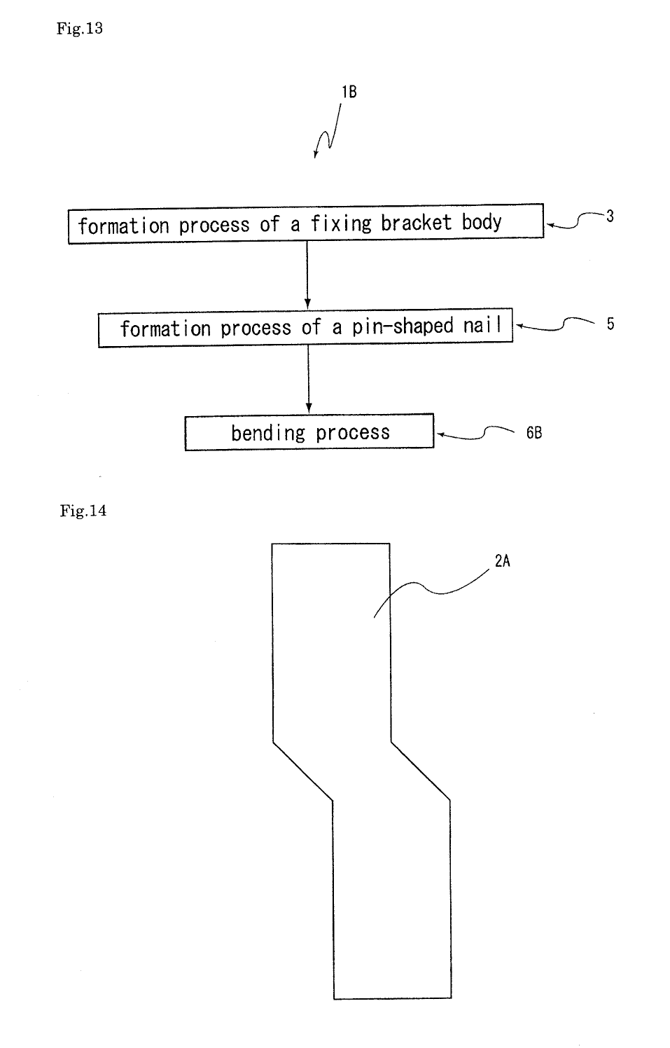

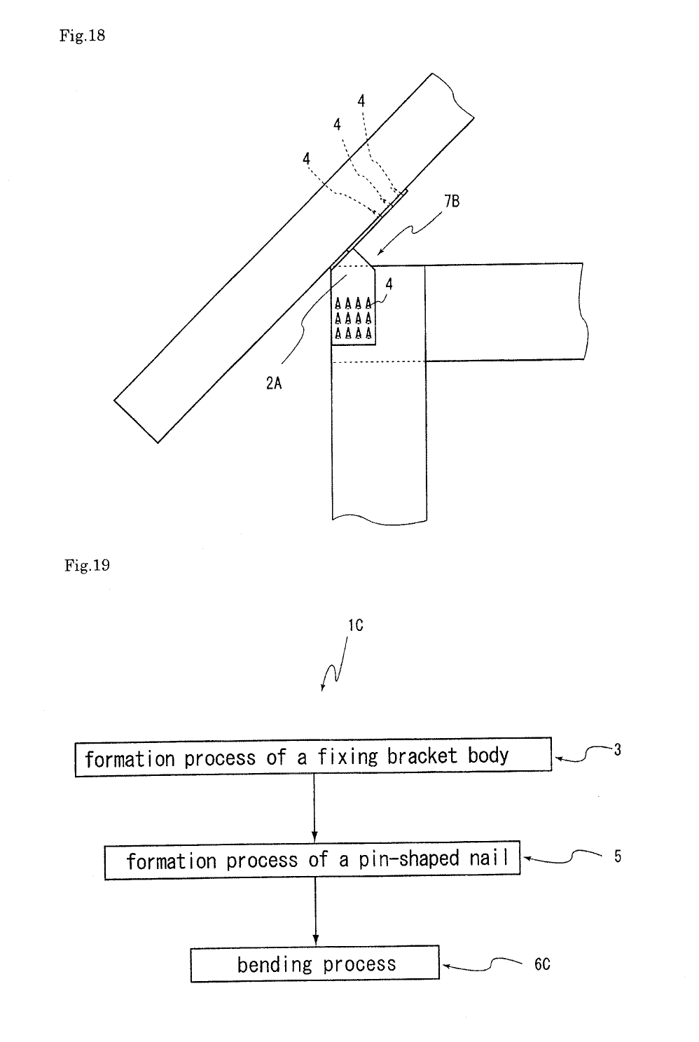

A third embodiment to practice the present invention is shown in FIGS. 13 to 18. It is distinguished from the first preferred embodiment that: a fixing bracket body 2A is formed by formation process of a fixing bracket body 3A, and the central part is bent by bending process 6B 45 degrees. For example, a fixing bracket body 2A is bent between base points 0,0 of the part which projects one by one to the both sides of side parts 2a, 2b, by a formation process of a fixing bracket body 3A and a bending process 6B. Therefore, a corner fixing bracket 7B manufactured by a method for manufacturing a corner fixing bracket 1B as described above will fix the connecting part bent 45 degrees as shown in FIG.18.

A fourth embodiment to practice the present invention is shown in FIGS. 19 to 23. It is distinguished from the third preferred embodiment that: a bending process 6C is performed so that plural pin-shaped nails 4 may be located inside. Therefore, a corner fixing bracket 7C manufactured by a method for manufacturing a corner fixing bracket 1C as described above will have similar action effects to that according to the third preferred embodiment to practice the present invention.

A fifth embodiment to practice the present invention is shown in FIGS. 24 to 28. It is distinguished from the first preferred embodiment that: a formation process of plural pin-shaped nails 5A which forms plural pin-shaped nails 4A which have key form tip parts is used. Therefore, a corner fixing bracket 7D manufactured by a method for manufacturing a corner fixing bracket 1D using a formation process of plural pin-shaped nails 5A as described above will fix a connecting part more strongly.

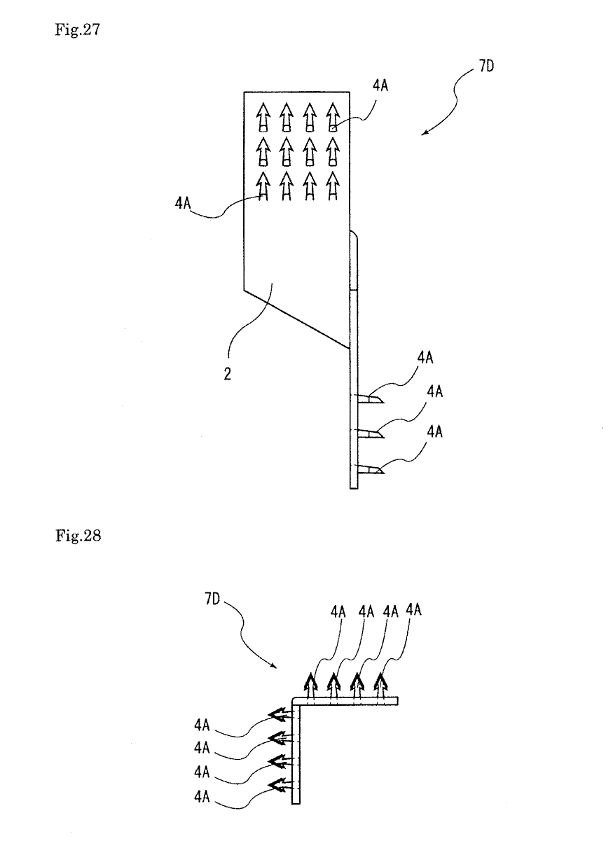

A sixth embodiment to practice the present invention is shown in FIGS. 27 to 32. It is distinguished from the fifth preferred embodiment that: a formation process of plural pin-shaped nails 5B which processes some of plural pin-shaped nails 4 of both ends parts to plural pin-shaped nails 4A which have key form tip parts is used. Therefore, a method for manufacturing a corner fixing bracket 1E using a formation process of plural pin-shaped nails 5B will be attached easily, and fix a connecting part strongly than a first embodiment of the present invention, although this does not fix a connecting part strongly than a fifth embodiment of the present invention.

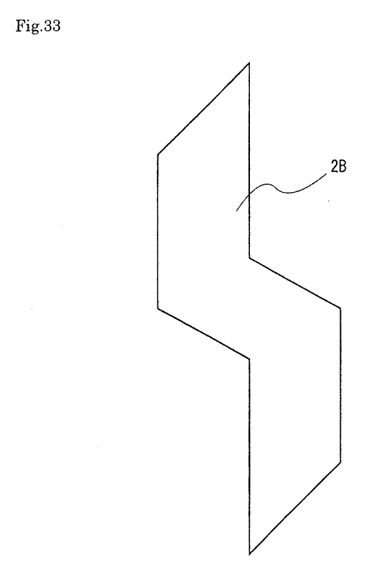

A seventh embodiment to practice the present invention is shown in FIGS. 33 to 36. It is distinguished from the first preferred embodiment that: a corner fixing bracket 7F uses a fixing bracket body 2B in which the upper and lower side are formed to a slope. Therefore, a corner fixing bracket 7F manufactured as described above will prevent the problem such as projecting upwards from the rafter connected, certainly.

An eighth embodiment to practice the present invention is shown in FIGS. 37 to 39. It is distinguished from the first preferred embodiment that: a corner fixing bracket 7G uses a fixing bracket body 2C in which the upper side is formed to a slope. Therefore, a corner fixing bracket 7G manufactured as described above will have similar action effects to that according to the seventh preferred embodiment to practice the present invention.

The present invention is applicable in the industry of manufacture of the corner fixing bracket for timber materials which fixes the connecting part of a beam and a beam, fixes the connecting part of a beam and a crossbeam, and fixes the connecting part of a rafter and a beam.

What is claimed is:

1. A method for manufacturing a corner fixing bracket comprising: a formation process of a tabular fixing bracket body which bends a generally central part to a predetermined angle; a formation process of plural pin-shaped nails which form plural pin-shaped nails by punching, in both ends parts except a central part of a fixing bracket body formed by said formation process of a fixing bracket body; and a bending process which bends a generally central part at 45 degrees or 90 degrees, after said formation process of plural pin-shaped nails.

2. A corner fixing bracket comprising: a tabular fixing bracket body which bent to a predetermined angle at a generally central part; and plural pin-shaped nails which is formed by punching, in both ends parts except a generally central part of said fixing bracket body.
